(19) United States
(12) Patent Application Publication
(10) Pub. No.: US 2017/0209999 A1
(43) Pub. Date: Jul. 27, 2017

(54) MULTIPURPOSE HAND HELD TOOLS

(71) Applicant: Shane Keng, Marietta, GA (US)

(72) Inventor: Shane Keng, Marietta, GA (US)

(21) Appl. No.: 15/450,587

(22) Filed: Mar. 6, 2017

Related U.S. Application Data
(63) Continuation of application No. 14/643,535, filed on Mar. 10, 2015, now Pat. No. 9,623,546.
Application No. 14/643,535 is a continuation of application No. 13/557,587, filed on Jul. 25, 2012, now abandoned.
(60) Provisional application No. 61/548,482, filed on Oct. 18, 2011.
(60) Provisional application No. 61/511,313, filed on Jul. 25, 2011.

(51) Int. Cl. B25F 1/04; B25G 1/08; B26B 11/00; B25F 1/00

(52) U.S. Cl. CPC B25F 1/04; B25F 1/003; B25G 1/085; B26B 11/001; B26B 11/008

(57) ABSTRACT

A multipurpose hand held tool includes a handle and one or more tools. The multipurpose tool may include an inletted recess defined in the handle, and an accessory tool retained within the inletted recess. The multipurpose tool also may include a rotatable tool and a locking mechanism for locking the rotatable tool in multiple positions. The multipurpose tool further may include a compact spanner wrench rotatably connected to the handle. The multipurpose tool may include a knife assembly detachably connected to the handle. The multipurpose tool also may include a ratcheting bit driver located within the handle. The multipurpose tool further may include a multi-layered plier head. The multipurpose may include a hybrid bearing system. The multipurpose tool also may include a flashlight detachably coupled to the handle. In this manner, the multipurpose tool may incorporate multiple tools and accessories for completing various tasks.

### CROSS-REFERENCE TO RELATED APPLICATIONS

The present application is a continuation of and claims priority to and the benefit of U.S. patent application Ser. No. 14/643,535, filed on Mar. 10, 2015, which is a continuation of and claims priority to and the benefit of U.S. patent application Ser. No. 13/557,587, filed on Jul. 25, 2012, which claims priority to and the benefit of U.S. Provisional Patent Application No. 61/511,313, filed on Jul. 25, 2011, and U.S. Provisional Patent Application No. 61/548,482, filed on Oct. 18, 2011, which are all incorporated by reference herein in their entirety.

### FIELD OF THE DISCLOSURE

The present application relates generally to hand held tools and more particularly to multipurpose hand held tools and accessories.

### BACKGROUND

Traditional multipurpose hand held tools combine various hand tools, instruments, and accessories in a compact and portable unit. For example, a multipurpose tool may include a knife blade, a saw blade, a file, a screwdriver, a hook, tweezers, scissors, and other commonly used tools. Certain multipurpose tools may combine different component tools and accessories that are all useful for a specific task or activity, such as cleaning a firearm, working in a shop, or camping. Many multipurpose tools have a folding configuration that allows a component tool to be rotated from a storage position to a deployed position. Such multipurpose tools may also include a locking mechanism for holding the component tool in the storage position or the deployed position. Other multipurpose tools may include a retention or coupling mechanism for retaining a detachable tool or accessory.

As the tool needs and desires of consumers evolve, there is a continuing demand for an improved multipurpose tool that combines more component tools and accessories in a single unit without the overall tool becoming too bulky to carry or too cumbersome to operate. Additionally, with regards to folding multipurpose tools, there is a desire to provide an improved locking mechanism that allows a component tool to be locked at different positions relative to a frame or handle of a multipurpose tool. Furthermore, there is a desire to provide an improved retention or coupling mechanism for incorporating detachable tools and accessories into a multipurpose tool. Such improvements would enable a user to complete more tasks quickly and safely, while also enhancing overall ease of use of a multipurpose tool.

### BRIEF DESCRIPTION OF THE DRAWINGS

The detailed description is set forth with reference to the accompanying drawings. The use of the same reference numerals indicates similar or identical items. Various embodiments may utilize elements and/or components other than those illustrated in the drawings and some elements and/or components may not be present in various embodiments. Throughout this disclosure, depending on the context, singular and plural terminology may be used interchangeably.

FIG. 1 depicts a front view of an example multipurpose hand held tool in accordance with one or more embodiments of the disclosure, wherein component tools are shown in a storage position.

FIG. 2 depicts a perspective view of a locking mechanism of the example multipurpose hand held tool in accordance with one or more embodiments of the disclosure, wherein component tools are shown in the storage position.

FIG. 3 depicts a perspective view of the locking mechanism of the example multipurpose hand held tool in accordance with one or more embodiments of the disclosure, wherein a component tool is shown in a first deployed position.

FIG. 4 depicts a perspective view of the locking mechanism of the example multipurpose hand held tool in accordance with one or more embodiments of the disclosure, wherein the component tool is shown in a second deployed position.

FIG. 5 depicts a top view of the example multipurpose hand held tool in accordance with one or more embodiments of the disclosure, wherein the component tool is shown in the storage position.

FIG. 6 depicts a perspective view of a component tool of the example multipurpose hand held tool in accordance with one or more embodiments of the disclosure, wherein the component tool is shown in a deployed position.

FIG. 7 depicts a top view of a component tool of the example multipurpose hand held tool in accordance with one or more embodiments of the disclosure, wherein the component tool is shown in a deployed position.

FIG. 8 depicts a top view of a component tool of the example multipurpose hand held tool in accordance with one or more embodiments of the disclosure, wherein the component tool is shown in the deployed position and engaging a castle nut.

### DETAILED DESCRIPTION OF THE DISCLOSURE

The present disclosure includes various examples of multipurpose hand held tools that address one or more of the above-mentioned areas of improvement. Specifically, one or more of the examples may include component tools or accessories that are not provided in existing multipurpose tools. Additionally, one or more of the examples may provide component tools or accessories in a novel configuration. Accordingly, the various examples disclosed may enable a user to complete more tasks quickly and safely, while also enhancing overall ease of use of the multipurpose tool.

For example, a multipurpose hand held tool is disclosed that may include a handle plate having an inner surface, an outer surface, and a cutout extending from the inner surface to the outer surface. The multipurpose tool also may include a rotatable tool connected to the handle plate. The rotatable tool may include a base and an arm, and a portion of the arm may be received within the cutout of the handle plate when the rotatable tool is in a storage position. In this manner, the cutout of the handle plate accommodates a rotatable tool having a large arm while minimizing overall dimensions of the handle of the multipurpose tool.

In another example, a multipurpose hand held tool is disclosed that may include a handle and a compact spanner wrench rotatably connected to the handle. The compact spanner wrench may be able to engage and rotate a castle nut. The compact spanner wrench may include a base and a head, and the head may be able to contact and extend around a circumferential surface of the castle nut. In certain embodiments, the head may include one or more engagement tabs for engaging notches of the castle nut. In this manner, the one or more engagement tabs of the head allow the compact spanner wrench to engage and rotate the castle nut in a clockwise or counter-clockwise direction.

These and other examples will be described in more detail through reference to the accompanying drawings in the following description. It is understood, however, that the multipurpose hand held tools are not limited to the details of construction and the arrangements of the components set forth in the detailed description or shown in the accompanying drawings. The multipurpose tools are capable of other embodiments and being produced in various alternative ways. Other embodiments, aspects, and features of the multipurpose tools will become apparent to those skilled in the art from the detailed description, the accompanying drawings, and the appended claims.

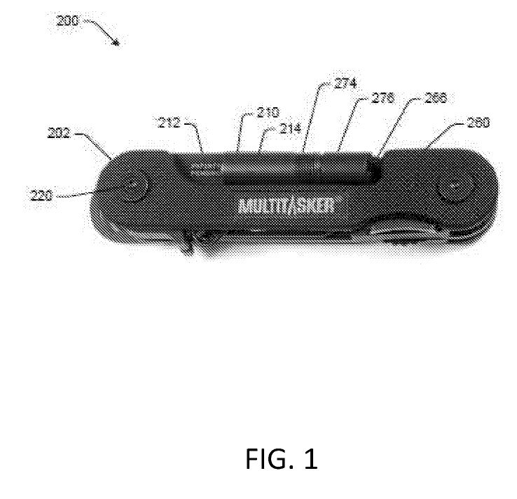

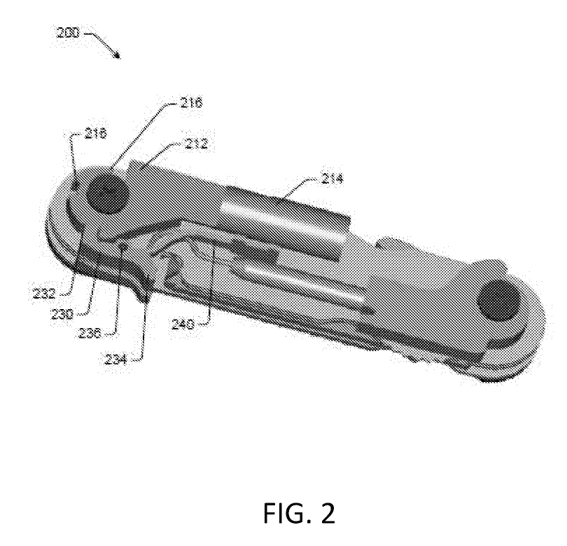

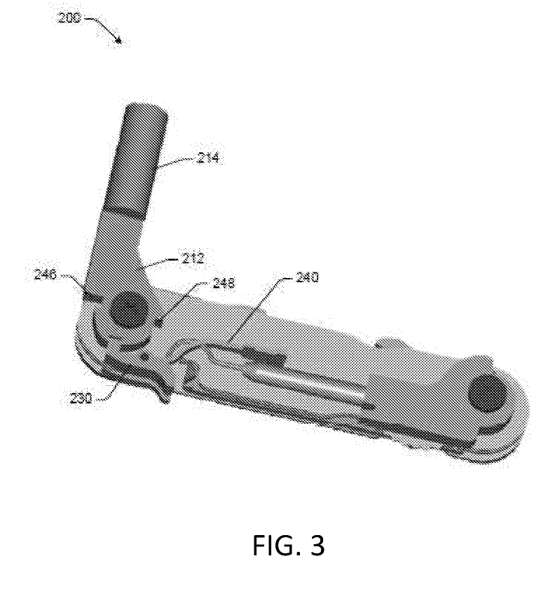

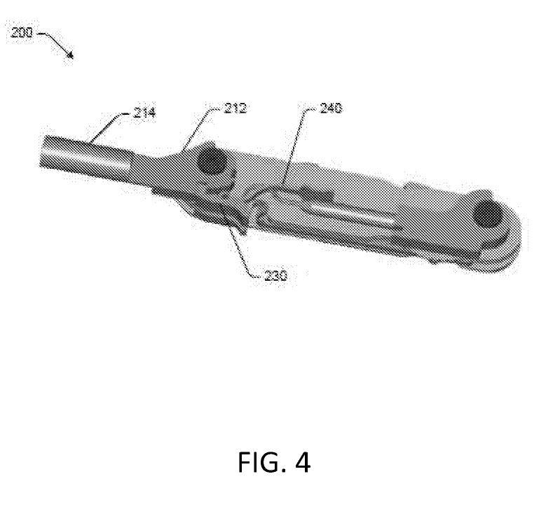

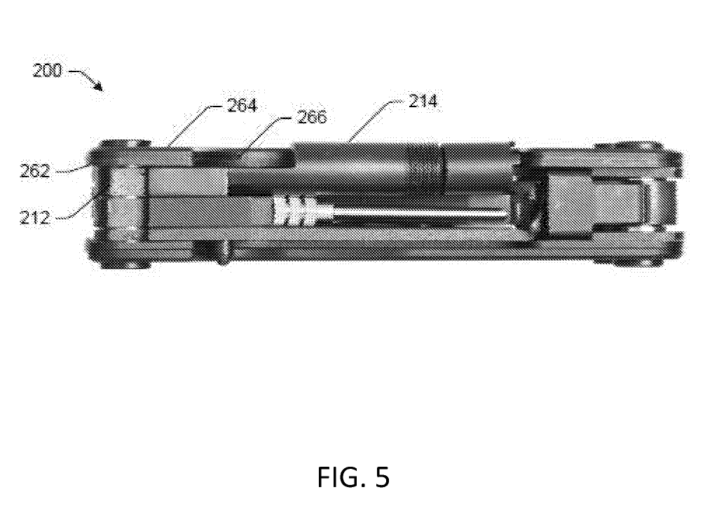

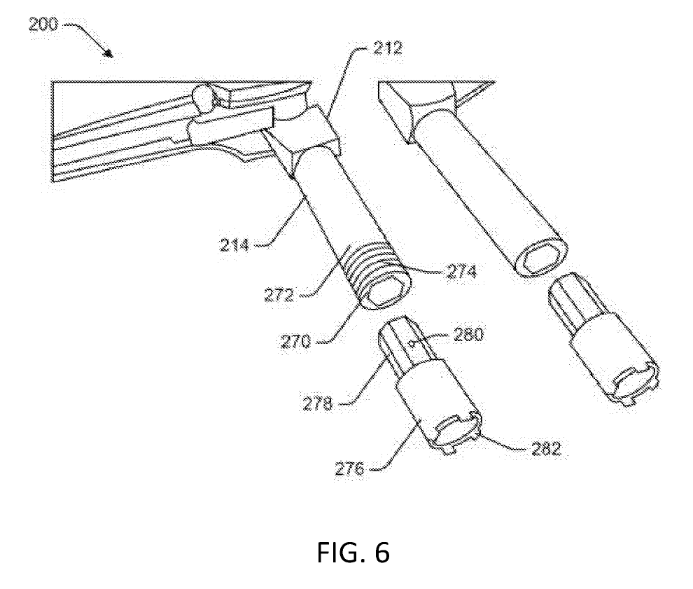

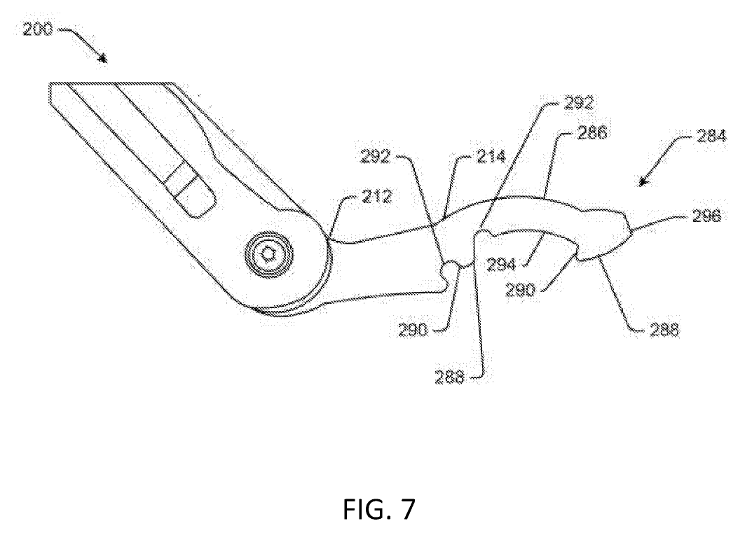

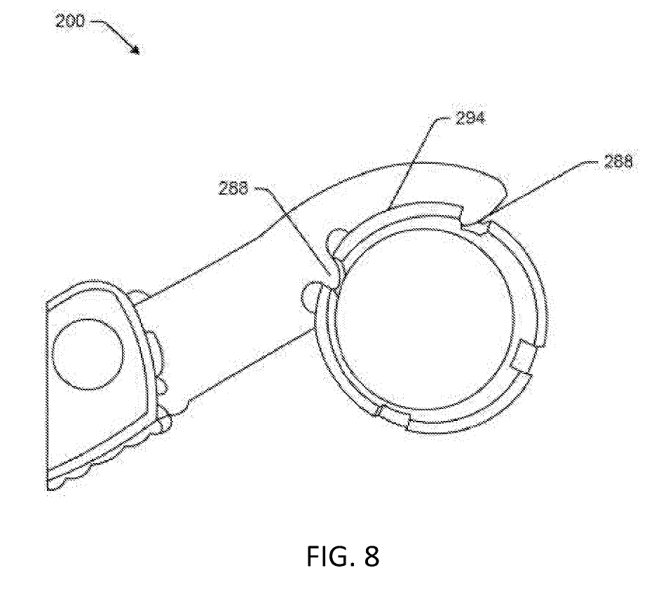

FIGS. 1-8 depict various views of a multipurpose hand held tool 200 in accordance with an embodiment of the disclosure. Specifically, FIG. 1 depicts a front view of the multipurpose tool 200 with component tools in a storage position, FIG. 2 depicts a perspective view of a locking mechanism of the multipurpose tool 200 with component tools in a storage position, FIG. 3 depicts a perspective view of the locking mechanism of the multipurpose tool 200 with a component tool in a first deployed position, FIG. 4 depicts a perspective view of the locking mechanism of the multipurpose tool 200 with the component tool in a second deployed position, and FIG. 5 depicts a top view of the multipurpose tool 200 with the component tool in the storage position, FIG. 6 depicts a perspective view of a component tool in a deployed position, FIG. 7 depicts a top view of a component tool in a deployed position, and FIG. 8 depicts a top view of the component tool in the deployed position and engaging a castle nut. Collectively referring to FIGS. 1-8, and by way of example, the multipurpose tool 200 may include a handle 202 and a rotatable tool 210 connected to the handle. The rotatable tool 210 may be rotatably connected to the handle 202 by one or more fasteners 220. Accordingly, the rotatable tool 210 may be rotated from a storage position, as shown in FIG. 1, to one or more deployed positions, as shown in FIG. 3.

In some examples, the rotatable tool 210 may include a base 212, an arm 214, and at least one cutout 216 positioned about an axis of the base 212. The multipurpose tool 200 also may include a pivotable catch 230 having a locking tab 232 for releaseably engaging the at least one cutout 216 of the rotatable tool 210. The locking tab 232 may be substantially rectangular in shape, and the at least one cutout 216 may be substantially U-shaped for securely receiving the locking tab 232. The pivotable catch 230 also may include a release lever 234 for pivoting the locking tab 232 away from the base 212 of the rotatable tool 210. The pivotable catch 230 further may include a pivot hole 236 positioned between the release lever 234 and the locking tab 232. In certain aspects, the pivotable catch 230 may be connected to the handle 202 by a pin 238 received through the pivot hole 236. The multipurpose tool 200 further may include a leaf spring 240 biasing the locking tab 232 toward the base 212 of the rotatable tool 210. The leaf spring 240 may directly contact the release lever 234 such that the locking tab 232 is biased toward the base 212 of the rotatable tool 210. In this manner, the locking tab 232 contacts the base 212 of the rotatable tool 210 unless the release lever 234 is depressed to pivot the locking tab 232 away from the base 212. In some aspects, the release lever 234 may extend beyond the handle 202 of the multipurpose tool 200 for ease of access of the release lever 234.

In certain examples, the rotatable tool 210 may include a plurality of cutouts 216 circumferentially spaced about the axis of the base 212. In this manner, the plurality of cutouts 216 and the locking tab 232 allow the rotatable tool 210 to be locked at different angles relative to the handle of the multipurpose tool. In some aspects, one of the plurality of cutouts 216 may be located such that the arm 214 of the rotatable tool 210 may be locked at a 90-degree angle relative to the handle 202 of the multipurpose tool 200. In other aspects, one of the plurality of cutouts 216 may be located such that the arm 214 of the rotatable tool 210 may be locked at a 180-degree angle relative to the handle 202 of the multipurpose tool 200. One will appreciate, however, that the plurality of cutouts 216 may be located such that the arm 214 of the rotatable tool 210 may be locked at any angle relative to the handle 202 of the multipurpose tool 200. In certain aspects, the rotatable tool 210 further may include a first stop 246 and a second stop 248 positioned about the axis of the base 212. The first stop 246 may be located to prevent rotation of the rotatable tool 210 in a first direction of rotation, and the second stop 248 may be located to prevent rotation of the rotatable tool 210 in a second direction of rotation. In some aspects, the first stop 246 and the second stop 248 may be configured to contact the locking tab 232 in order to prevent rotation of the rotatable tool 210. Additionally, the first stop 246 and the second stop 248 may be configured to contact the locking tab 232 and prevent rotation of the rotatable tool 210 whether the release lever 234 is depressed or not. In certain instances, each of the first stop 246 and the second stop 248 may be positioned about the base 212 of the rotatable tool 210 and adjacent one of the plurality of cutouts 216.

In some examples, the handle 202 of the multipurpose tool 200 may include a handle plate 260 having an inner surface 262, an outer surface 264, and a cutout 266 extending from the inner surface 262 to the outer surface 264. As shown in FIGS. 1 and 5, when the rotatable tool 210 is in the storage position, a portion of the arm 214 of the rotatable tool 210 may be received within the cutout 266 of the handle plate 260. In this manner, the cutout 266 of the handle plate 260 accommodates the rotatable tool 210 having a large arm 214 while minimizing overall dimensions of the handle 202 of the multipurpose tool 200. In certain aspects, a portion of the arm 214 may be flush with the outer surface 264 of the handle plate 260 when the rotatable tool 210 is in the storage position. Alternatively, a portion of the arm 214 may extend through the cutout 266 and beyond the outer surface 264 of the handle plate 260 when the rotatable tool 210 is in the storage position. In certain aspects, a width of the arm 214 may be greater than a width of the base 212 of the rotatable tool 210. In some aspects, the arm 214 may be laterally offset relative to the base 212 of the rotatable tool 210. In certain aspects, a cross-section of the arm 214 may be substantially circular, and a cross-section of the base 212 may be substantially rectangular. Accordingly, the cutout 266 of the handle plate 260 may accommodate a rotatable tool 210 having a large width or an offset configuration, while minimizing the overall width of the multipurpose tool 200.

In certain examples, the rotatable tool 210 may include a hex bit driver 270 positioned at an end of the arm 214, as shown in FIG. 6. The hex bit driver 270 may be a ¼-inch driver that allows for compatibility with common hardware tool bits used for engaging and driving various types of fasteners. In some aspects, the hex bit driver 270 includes an internal magnet 272 for releaseably retaining metal tool bits. Accordingly, the hex bit driver 270 may be used in an inverted manner while retaining a mating tool bit. In certain aspects, the hex bit driver 270 may include threads 274 defined on an external surface for attachment of threaded tools or accessories. Particularly, the threads 274 may be used for attachment of tools or accessories that are used in a prying or levering manner and that would not be adequately retained by a hex connection. In some aspects, the rotatable tool 210 further may include a tool bit 276 releaseably received by the hex bit driver 270. When the rotatable tool 210 is in the storage position, a portion of the tool bit 276 may be received within the cutout 266 of the handle plate 260 of the multipurpose tool 200. The tool bit 276 may include a hex base 278 and a ball detent 280 positioned within the hex base for secure retention within the hex bit driver 270. In certain aspects, the tool bit 276 may include a working end having a plurality of posts 282 for engaging specific cutouts or recesses defined in a mating fastener or other component.

In some examples, the rotatable tool 210 may include a compact spanner wrench 284 positioned at an end of the arm 214, as shown in FIGS. 7 and 8. The compact spanner wrench 284 may be able to engage and rotate a castle nut. In certain aspects, the compact spanner wrench 284 may include a head 286 having an arc shape such that the head is able to contact and extend around a circumferential surface of the castle nut. The head 286 may be configured to extend less than 180-degrees around the circumferential surface of the castle nut. One will appreciate, however, that the head 286 may be configured to extend any number of degrees around the circumferential surface of the castle nut. Accordingly, the outer dimensions of the head 286 may be minimized such that the compact spanner wrench 284 may be incorporated into as small of a handle 202 as possible. In certain aspects, the head 286 may include one or more engagement tabs 288 for engaging notches of the castle nut. In this manner, the one or more engagement tabs 288 of the head 286 allow the compact spanner wrench to engage and rotate the castle nut in a clockwise or counter-clockwise direction. In some aspects, the head 286 may include two engagement tabs 288 for engaging two adjacent notches of the castle nut. One will appreciate, however, that the head 286 may include any number of engagement tabs 288 for engaging any number of notches, adjacent or non-adjacent, of the castle nut. In certain aspects, one of the engagement tabs 288 may have an asymmetric shape such that the engagement tab 288 contacts only one axial surface of a notch of the castle nut when the head 286 engages the castle nut. Accordingly, the engagement tabs 288 each may include a contact surface 290 for contacting an axial surface of a notch of the castle nut. In some aspects, the head 286 may include one or more relief cutouts 292 adjacent at least one of the engagement tabs 288. The head 286 also may include a support surface 294 positioned between two engagement tabs 288 such that the support surface 294 is able to contact the circumferential surface of the castle nut when the two engagement tabs 288 engage notches of the castle nut. In certain aspects, the head 286 may include a screwdriver tip 296 located at an end of the head 286.

Although specific embodiments of the disclosure have been described, one of ordinary skill in the art will recognize that numerous other modifications and alternative embodiments are within the scope of the disclosure. Further, while embodiments of the disclosure have been described with respect to specific examples of multipurpose tool configurations, it will be appreciated that numerous other multipurpose tool configurations are within the scope of this disclosure. Still further, while embodiments of the disclosure have been described with respect to specific types of multipurpose tools, one should appreciate that numerous other types of multipurpose tools are within the scope of this disclosure.

Although embodiments have been described in language specific to structural features, it is to be understood that the disclosure is not necessarily limited to the specific features described. Rather, the specific features are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features and/or elements. Thus, such conditional language is not generally intended to imply that features and/or elements are in any way required for one or more embodiments.

1-20. (canceled)

21. A multipurpose hand held tool, comprising:
a handle; and
a rotatable tool attached to the handle,
wherein the rotatable tool comprises a compact spanner wrench positioned at an end of an arm 214

22. The multipurpose hand held tool of claim 21, wherein the compact spanner wrench engages and rotates a castle nut.

23. The multipurpose hand held tool of claim 21, wherein the compact spanner wrench comprises a head having an arc shape such that the head is able to contact and extend around a circumferential surface of a castle nut.

24. The multipurpose hand held tool of claim 23, wherein the head is configured to extend less than 180-degrees around the circumferential surface of the castle nut.

25. The multipurpose hand held tool of claim 23, wherein the head comprises one or more engagement tabs for engaging notches of the castle nut.

26. The multipurpose hand held tool of claim 25, wherein the one or more engagement tabs face outward away from the handle when the compart spanner wrench is rotated in a closed position therein.

27. The multipurpose hand held tool of claim 25, wherein the head comprises two engagement tabs for engaging two adjacent notches of the castle nut.

28. The multipurpose hand held tool of claim 27, wherein one of the engagement tabs comprises an asymmetric shape such that the engagement tab contacts only one axial surface of a notch of the castle nut when the head engages the castle nut.

29. The multipurpose hand held tool of claim 25, wherein the head comprises one or more relief cutouts adjacent at least one of the engagement tabs.

30. The multipurpose hand held tool of claim 25, wherein the head comprises a support surface positioned between two engagement tabs such that the support surface is able to contact a circumferential surface of the castle nut when the two engagement tabs engage notches of the castle nut.

31. The multipurpose hand held tool of claim 23, wherein the head comprises a screwdriver tip located at an end of the head.
